(19) United States
(12) Patent Application Publication
(10) Pub. No.: US 2007/0176399 A1
(43) Pub. Date: Aug. 2, 2007

(54) TRIM PANEL FOR A MOTOR VEHICLE

(75) Inventor: Christian Kullack, Ebersberg (DE)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: LEAR CORPORATION, Southfield, MI (US)

(21) Appl. No.: 11/623,549

(22) Filed: Jan. 16, 2007

(30) Foreign Application Priority Data
Jan. 18, 2006 (DE) 10 2006 002 467.2

(51) Int. Cl. B60R 21/20

(52) U.S. Cl. 280/728.3

(57) ABSTRACT

A trim panel for a motor vehicle. The trim panel includes a panel body, a support, and a clip mechanism. The clip mechanism includes an arm having a frangible portion and a hinge portion. The frangible portion severs from the support to permit the arm to pivot about the hinge portion.

### CROSS-REFERENCE TO RELATED APPLICATIONS

This application claims foreign priority benefits under 35 U.S.C. § 119(a)-(d) to DE 10 2006 002 467.2, filed Jan. 18, 2006, which is hereby incorporated by reference in its entirety.

### BACKGROUND OF THE INVENTION

### Field of the Invention

The present invention relates to a trim panel for a motor vehicle, and more particularly to a trim panel that permits the deployment of an occupant safety device, such as an airbag.

### SUMMARY OF THE INVENTION

In at least one embodiment of the present invention, a trim panel for a motor vehicle is provided. The trim panel includes a panel body, a support, and a clip mechanism. The panel body has an inner surface and an outer surface disposed opposite the inner surface. The support is disposed on the inner surface. The clip mechanism has an arm and a clip portion. The arm has a hinge portion disposed adjacent to the support and a frangible portion. The clip portion is disposed on the arm and extends away from the support. The frangible portion severs from the support to permit the arm to pivot about the hinge portion.

In at least one other embodiment of the present invention, a trim panel for a motor vehicle is provided. The trim panel includes a unitary panel body and a unitary clip mechanism. The unitary panel body has an inner surface, an outer surface disposed opposite the inner surface, and a support extending from the inner surface. The unitary clip mechanism has an arm and a clip portion that extends from the arm. The arm has a hinge portion coupled to the support and a frangible portion. The frangible portion is attached to the support to inhibit the arm from pivoting about the hinge portion when the clip mechanism is in a first position. The frangible portion is detached from the support to permit the arm to pivot about the hinge portion and away from the support toward a second position.

In at least one other embodiment of the present invention, a unitary trim panel for concealing an airbag for a motor vehicle is provided. The unitary trim panel includes a panel body having an inner surface, a support disposed on the inner surface, and a clip mechanism. The clip mechanism includes an arm and a clip portion. The arm has a hinge portion disposed adjacent to the support and a frangible portion spaced apart from the hinge portion. The clip portion extends from the arm. The arm is inhibited from pivoting about the hinge portion when the frangible portion is attached directly to the support. The frangible portion severs from the support when sufficient force is exerted upon the inner surface.

### BRIEF DESCRIPTION OF THE DRAWINGS

FIG. 1 is a perspective view of a trim panel mounted in a vehicle.

FIG. 2 is a section view of the trim panel along line 2-2 illustrating the trim panel in a first position.

FIG. 3 is a section view of the trim panel along line 2-2 illustrating the trim panel in a second position.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

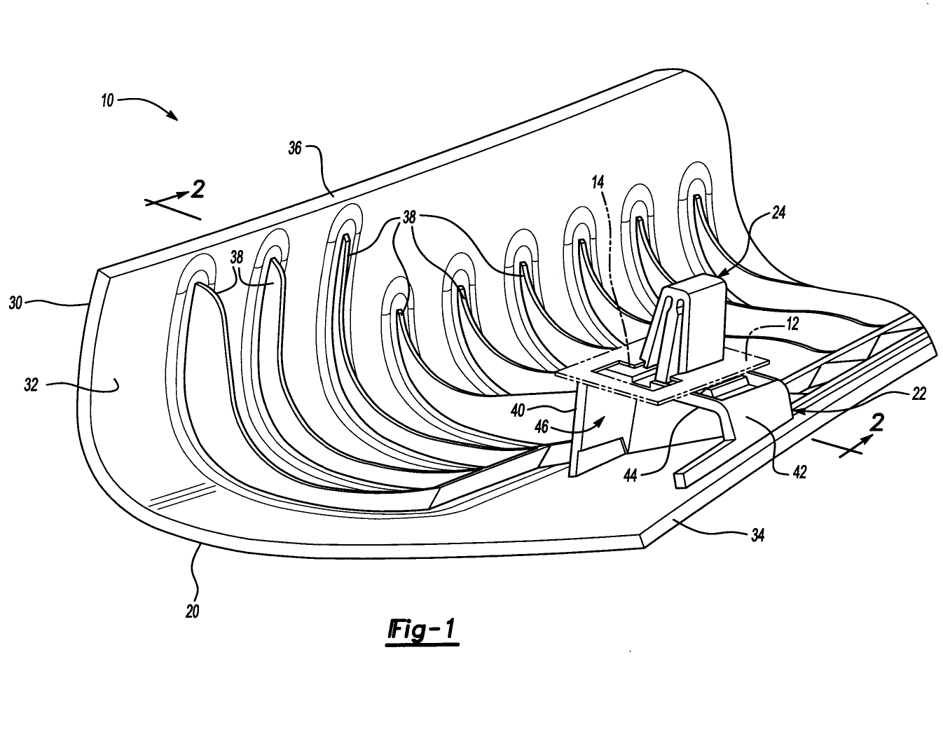

Referring to FIG. 1, an exemplary trim panel 10 in accordance with the present invention is shown. The trim panel 10 may be adapted to conceal an occupant safety device, such as an airbag module that is configured to deploy a front, side or side curtain airbag.

The trim panel 10 may be configured to be mounted to any suitable vehicle surface 12, such as a vehicle body surface like a support pillar or A-pillar. In FIG. 1, the vehicle surface 12 is represented by phantom lines. An opening 14 may be disposed in the vehicle surface 12 for receiving a portion of the trim panel 10 as will be described in more detail below. In other embodiments of the present invention, the trim panel 10 may be mounted to another vehicle component, such as a mounting bracket.

The trim panel 10 may have any suitable configuration. For example, the trim panel 10 may include a panel body 20, one or more supports 22, and one or more clip mechanisms 24. The panel body 20 may be integrally formed with the support 22 or the support 22 and the clip mechanism 24 to form a unitary component. Such a unitary component may be made of a polymeric material like polypropylene and may be made using any suitable technique, such as injection molding.

The panel body 20 may be configured to be installed in a passenger compartment of a vehicle. The panel body 20 may include an inner surface 30, an outer surface 32, a first end 34, and a second end 36. The inner surface 30 may be provided with one or more ribs 38 to help improve the strength and/or dimensional stability of the panel body 20.

The support 22 may extend from the inner surface 30 of the panel body 20. The support 22 may have any suitable configuration. In the embodiment shown, the support 22 includes a first wall 40, a second wall 42, and a third wall 44. The first and second walls 40,42 may extend from the inner surface 30. The third wall 44 may extend between the first and second walls 40,42 and may be spaced apart from the inner surface 30 to define a hollow region 46. The hollow region 46 may be provided to help reduce material and weight. The third wall 44 may also define a recess 48 that receives at least a portion of the clip mechanism 24 as is described in more detail below. The support 22 may be provided in any suitable location. In the embodiment shown, the support 22 is provided near the first end 34 of the panel body 20.

Referring to FIGS. 1-3, the clip mechanism 24 is shown in more detail. The clip mechanism 24 may be configured to facilitate installation and movement of the trim panel 10. In at least one embodiment, the clip mechanism 24 may include an arm 50, a clip portion 52, a hinge portion 54, and a frangible portion 56.

The arm 50 may connect the clip portion 52 to the support 22. In the embodiment shown, the arm 50 includes a first end 60 and a second end 62 disposed opposite the first end 60. The first end 60 may be integrally formed with and disposed adjacent to the support 22. The second end 62 may be disposed near or adjacent to the clip portion 52. A gap may be provided between the arm 50 and the support 22 on one or more sides, such as a bottom side that faces the support 22.

The clip portion 52 may facilitate attachment of the trim panel 10 to the vehicle. The clip portion 52 may have any suitable configuration. In the embodiment shown, the clip portion 52 includes a center member 70 and opposing side members 72. The opposing side members 72 may extend from a distal end of the center member 70 and toward the support 22 at an acute angle relative to the center member 70. As such, a gap may be provided between each side member 72 and the center member 70 that permits the side members 72 to flex toward the center member 70 when the clip portion 52 is inserted into the opening 14. The clip portion 52 may be provided with any suitable orientation. For example, the clip portion 52 may extend away from the arm 50 at any suitable angle. In the embodiment shown, the clip portion 52 extends generally perpendicular from the arm 50 and the third wall 44 of the support 22.

The hinge portion 54 may be configured to permit the arm 50 to pivot with respect to the support 22. The hinge portion 54 may have any suitable configuration. For example, the hinge portion 54 may be configured as an area of reduced thickness or strength, such as an indentation, groove, or perforation. In the embodiment shown, the hinge portion 54 is depicted as a generally linear groove that is disposed at the first end 60 of the arm 50. The generally linear groove is disposed on an upper surface that faces away from the support 22, thereby allowing the support 22 to move away from the arm 50.

The frangible portion 56 may be configured to sever when sufficient force is applied to the trim panel 10. The frangible portion 56 may be provided in any suitable location, such as along or near one or more sides of the arm 50. In the embodiment shown, the frangible portion 56 is disposed at the second end 60 of the arm 50. The frangible portion 56 may be integrally formed with the support 22 and may be configured as an area of reduced thickness or strength, such as an indentation, groove, or perforation. In the embodiment shown, the frangible portion 56 is configured as a thin wall that severs when sufficient force is applied to the inner surface 30 of the trim panel 10. Severing of the frangible portion 56 allows the arm 50 to pivot about the hinge portion 54.

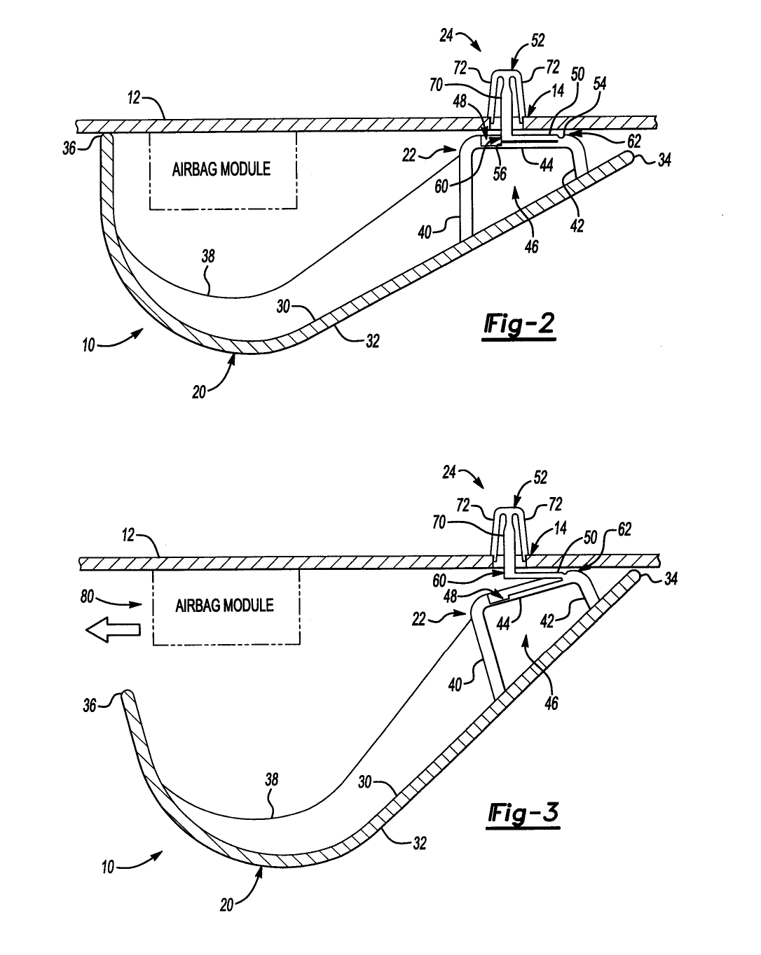

Referring to FIGS. 2 and 3, movement of trim panel 10 between a first position and a second position is shown.

In FIG. 2, the trim panel 10 is shown in the first position. The trim panel 10 may be disposed in the first position when the frangible portion 56 is not severed, such as prior to deployment of an occupant safety device. At least a portion of the arm 50 may be disposed in the recess 48 when the trim panel 10 is in the first position.

In FIG. 3, the trim panel 10 is shown in the second position. The trim panel 10 may move toward the second position when sufficient force is provided to sever the frangible portion 56 and move the trim panel 10. Sufficient force may be provided by the inflation of an airbag, which may be concealed by the trim panel 10 prior to deployment. Upon severing of the frangible portion 56, the arm 50 is free to pivot about the hinge portion 54, thereby allowing the second end 36 of the panel body 20 to move away from the vehicle surface 12. A gap 80 may be formed between the trim panel 10 and the vehicle through which an airbag may expand as is indicated by the arrowed line. In addition, the clip and hinge portions 52,54 may not detach from the vehicle surface 12 and support 22, respectively, when the trim panel 10 moves toward the second position.

The present invention allows a panel body, support, and/or a clip mechanism to be integrally formed, thereby reducing cost and complexity. For example, by integrally forming the clip mechanism and support, a separate metal clip and its associated assembly steps may be eliminated. In addition, the present invention provides a trim panel that facilitates airbag deployment without the need for tear seams or a deployment door defined within the trim panel, thereby eliminating undesirable seams and associated manufacturing steps. In addition, the trim panel may be easily replaced, such as may be required after airbag deployment, thereby reducing repair costs and repair time.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A trim panel for a motor vehicle, the trim panel comprising:
a panel body having an inner surface and an outer surface disposed opposite the inner surface;
a support disposed on the inner surface; and
a clip mechanism including:
an arm having a hinge portion disposed adjacent to the support and a frangible portion, and
a clip portion disposed on the arm and extending away from the support;
wherein the frangible portion severs from the support to permit the arm to pivot about the hinge portion.

2. The trim panel of claim 1 wherein the arm is disposed adjacent to the support when the frangible portion is attached directly to the support.

3. The trim panel of claim 1 wherein the hinge portion is disposed at a first end of the arm.

4. The trim panel of claim 3 wherein the frangible portion is disposed at a second end of the arm.

5. The trim panel of claim 1 wherein the clip portion includes a center wall having a distal end and first and second side walls that extend from the distal end toward the support at an acute angle relative to the center wall.

6. The trim panel of claim 1 wherein the support includes first and second walls that extend from the inner surface and a third wall that is spaced apart from the inner surface and extends between the first and second walls.

7. The trim panel of claim 6 wherein the hinge portion is disposed adjacent to the third wall.

8. The trim panel of claim 6 wherein the third wall includes a recess that extends toward the inner surface and wherein at least a portion of the arm is disposed in the recess before the frangible portion is severed.

9. The trim panel of claim 6 wherein the hinge portion is disposed closer to the first wall than the second wall.

10. A trim panel for a motor vehicle, the trim panel comprising:
a unitary panel body including:
an inner surface,
an outer surface disposed opposite the inner surface, and
a support extending from the inner surface; and
a unitary clip mechanism including:
an arm having a hinge portion coupled to the support and a frangible portion, and
a clip portion extending from the arm;
wherein the frangible portion is attached to the support to inhibit the arm from pivoting about the hinge portion when the clip mechanism is in a first position and the frangible portion is detached from the support to permit the arm to pivot about the hinge portion and away from the support toward a second position.

11. The trim panel of claim 10 wherein the support includes a hollow region disposed between the arm and the inner surface.

12. The trim panel of claim 10 wherein the frangible portion severs when sufficient force is applied to the inner surface.

13. The trim panel of claim 10 wherein the clip portion is configured to flex to facilitate insertion through an opening.

14. The trim panel of claim 10 wherein the unitary panel body includes a plurality of ribs disposed on the inner surface.

15. The trim panel of claim 10 wherein the unitary panel body includes a first end and a second end disposed opposite the first end, wherein the support and the unitary clip mechanism are disposed near a first end of unitary panel body and the arm is oriented such that the hinge portion is disposed near the first end of the unitary panel body and the frangible portion is disposed closer to the second end of the unitary panel body than the first end of the unitary panel body.

16. A unitary trim panel for concealing an airbag for a motor vehicle, the unitary trim panel comprising:
a panel body having an inner surface;
a support disposed on the inner surface; and
a clip mechanism including:
an arm having a hinge portion disposed adjacent to the support and a frangible portion spaced apart from the hinge portion; and
a clip portion extending from the arm;
wherein the arm is inhibited from pivoting about the hinge portion when the frangible portion is attached directly to the support and the frangible portion severs from the support when sufficient force is exerted upon the inner surface.

17. The unitary trim panel of claim 16 wherein arm includes a first end and a second end disposed opposite the first end and wherein the hinge portion is disposed at the first end and the frangible portion is disposed at the second end.

18. The unitary trim panel of claim 16 wherein the clip portion extends generally perpendicular to the arm.

19. The unitary trim panel of claim 16 wherein the clip portion extends generally perpendicular to the support and away from the inner surface.

20. The unitary trim panel of claim 16 wherein the support includes a recess and the arm is disposed adjacent to the recess before the frangible portion is severed.
